(19) United States
(12) Patent Application Publication
(10) Pub. No.: US 2020/0104910 A1
(43) Pub. Date: Apr. 2, 2020

(54) Competitive Project-Bidding System

(71) Applicants: Andrew Devlin, Aptos, CA (US); Benjamin Norton, San Francisco, CA (US)

(72) Inventors: Andrew Devlin, Aptos, CA (US); Benjamin Norton, San Francisco, CA (US)

(73) Assignee: PitchHub, Inc., Newark, DE (US)

(21) Appl. No.: 16/144,596

(22) Filed: Sep. 27, 2018

(51) Int. Cl. G06Q 30/08; G06Q 40/06; G06Q 30/06

(52) U.S. Cl. CPC G06Q 30/08; G06Q 30/0613; G06Q 30/0641; G06Q 40/06

(57) ABSTRACT

A system for bidding on projects has an Internet-connected server executing software on a processor, providing a web site, a plurality of computerized devices used by participants, a registration process wherein project authors are registered, and profiles are maintained for each registered PA, first interactive interfaces provided to PAs using individual ones of the computerized devices connected to the web site, enabling and guiding the PAs to create projects, to select potential bidders, and to invite the potential bidders to bid on the projects, second interactive interfaces provided to potential Bidders responding to invitations to register as Bidders, creating profiles for the Bidders, third interactive interfaces provided to Bidders, enabling and guiding the Bidders to create video-based bids on projects, and to submit the bids to the PAs of the projects, wherein PAs play the video-based bids associated with projects, and select one Bidder to implement the project.

### BACKGROUND OF THE INVENTION

### 1. Field of the Invention

The instant invention is in the technical area of soliciting competitive proposals and managing disposition.

### 2. Description of Related Art

Requests for project management and quotation are well-known in the art. In a conventional system a project manager, for example, may author requirements for a project, which may vary in content widely, depending on the nature of the project. As an example, a purchasing agent might be responsible for purchasing a quantity of a machine part needed for maintenance and repair of manufacturing equipment. The agent may have blueprints fully describing the part, including, for example, heat treatment and finishing requirements. The agent may also have an idea of a maximum price the enterprise he represents may be willing to pay, and may define other criteria, such as a volume discount for example. Time frames for delivery may be specified, as well as packaging for delivery.

When the agent has fully defined the request, the request may be communicated to known sources of supply with which the agent has past experience and may trust. The communication may be by conventional mail, by email with attachment, or perhaps by posting on a web site.

After agents of the potential sources receive the request, often termed in the art a request for quote (RFQ), those agents will typically prepare a formal quotation, and transmit that back to the agent that formulated the RFQ.

This process is not limited to businesses, manufacturers, and purchasing agents. As a second example, an individual homeowner may have a need for a new roof. A typical process in this circumstance may be that the individual may simply call a local roofing business, and ask for someone to come by his home, look at the roof, and prepare a quotation. In this circumstance the individual homeowner may well call more than one roofing company to solicit individual quotations, and then compare the quotes to choose a roofing company to complete the project. Often a formal contract will be prepared and signed.

The skilled person will understand that the needs and circumstances may vary widely in this process, but that there are many similarities. There also are specific problems that may be common to different projects and processes of requesting solutions. For example, typically the returned quotations or proposals will be in text and graphics, and for careful consideration may require printing and comparison to make a decision. Further, it is not likely that all proposals or quotes will arrive at the same time, so some scheduling is required to organize the consideration of multiple proposals.

What is clearly needed is a system wherein the author of a project has a variety of digital tools to create the request, and is fully in charge of the process, and wherein the individuals or enterprises that may respond are constrained to respond in a pre-defined process, that provides the responses in a defined format that makes them easier for the author to consider and compare. In a preferred system, responders may be provided with state-of-the-art tools as well, to provide proposals and quotations in video presentation.

### BRIEF SUMMARY OF THE INVENTION

In one embodiment of the present invention a system for competitive bidding on defined projects is provided, comprising an Internet-connected server hosted by a first enterprise, executing software on a processor from a non-transitory medium, providing a web site, a plurality of Internet-connected, computerized devices used by participants in interacting with the first enterprise, a registration process wherein project authors (PAs) are registered to interact with the system, and profiles are created and maintained for each registered PA, first interactive interfaces provided to PAs using individual ones of the computerized devices connected to the web site, enabling and guiding the PAs to create projects, to select potential bidders, and to invite the potential bidders to bid on the projects, second interactive interfaces provided to potential Bidders responding to invitations to register as Bidders, creating profiles for the Bidders, and third interactive interfaces provided to Bidders, enabling and guiding the Bidders to create video-based bids on projects, and to submit the bids to the PAs of the projects. PAs play the video-based bids associated with projects and select one Bidder to implement the project.

In one embodiment projects created are accorded a status as either private, shared only with members of a specific organization, private with a shareable link, or public to anyone. Also, in one embodiment, in processing a project with a shareable link, projects are communicated to selected potential bidders in emails having a link connecting the potential bidders back to the enterprise web site and enabling the potential bidders to view details of the projects to which they have been invited as potential bidders. In one embodiment potential bidders deciding to bid on projects to which they are registered, are enabled to submit the video-based bids prepared to be considered by PAs of the associated projects. And in one embodiment activities of PAs and Bidders are recorded in profiles associated with the PAs and Bidders.

In one embodiment of the system projects are based on purchase of physical entities, either commercially available or manufacturable. Also, in one embodiment projects include purchase and installation of physical entities. Also, in one embodiment projects are based on investment for new businesses, investors are authors, and bidders are enterprises seeking investment. In one embodiment projects are created by authors seeking instruction or coaching, and bidders selected and invited are persons or enterprises capable of providing specific instruction or coaching described in the projects. And in one embodiment, at conclusion of a project, a project summary and report is prepared and recorded at least in the PAs profile.

In another aspect of the invention a method enabling competitive bidding on defined projects is provided, comprising registering project authors (PAs) with associated profiles to an enterprise hosting a web site provided by software executing on a processor of an Internet-connected server, enabling and guiding registered PAs to create projects through interactive interfaces provided to first computerized devices connected to the web site, used by the PAs, and executing a browser program, and to select potential bidders, and to invite selected potential bidders to bid on the projects, registering potential bidders, using second internet-connected computerized devices executing browser programs, who choose to respond to projects, as bidders with profiles, enabling and guiding bidders through second interactive interfaces, in preparing video-based bids on specific projects, and to submit the bids to the web site to be associated with specific projects, and enabling the PAs to play and consider the video-based bids, and to select one bidder to implement the project.

In one embodiment the method comprises according a status as either private, shared only with members of a specific organization, private with a shareable link, or public to anyone to each project created. Also, in one embodiment, in processing a project with a shareable link, projects are communicated to selected potential bidders in emails having a link connecting the potential bidders back to the enterprise web site and enabling the potential bidders to view details of the projects to which they have been invited as potential bidders. Also, in one embodiment potential bidders deciding to bid on projects to which they are registered, are enabled to submit the video-based bids prepared to be considered by PAs of the associated projects. And in one embodiment the method comprises recording activities of PAs and Bidders in profiles associated with the PAs and Bidders.

In one embodiment of the method projects are be based on purchase of physical entities, either commercially available or manufacturable. In one embodiment projects include purchase and installation of physical entities. In one embodiment projects are based on investment for new businesses, investors are authors, and bidders are enterprises seeking investment. In one embodiment projects are created by authors seeking instruction or coaching, and bidders selected and invited are persons or enterprises capable of providing specific instruction or coaching described in the projects. And in one embodiment the method comprises preparing a summary and report at conclusion. of a project and recording the summary or report at least in the PAs profile.

### BRIEF DESCRIPTION OF THE SEVERAL VIEWS OF THE DRAWINGS

FIG. 1 is an architectural diagram of a system in an embodiment of the invention.

FIG. 2 is a block diagram indicating a range of functionality provided by the enterprise domain in some embodiments of the invention.

FIG. 3 is a flow diagram depicting flow of activity in one embodiment of the invention.

FIG. 4A is an example of interactive interfaces in an embodiment of the invention.

FIG. 4B illustrates another interactive interface in an embodiment of the invention.

### DETAILED DESCRIPTION OF THE INVENTION

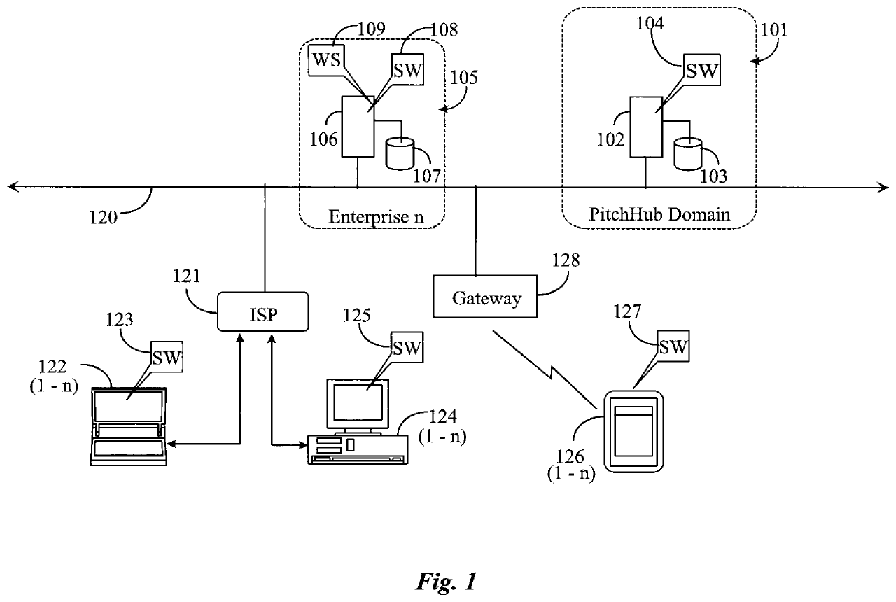

FIG. 1 is an architectural diagram of a system in an embodiment of the invention. In this system an enterprise domain 101, termed by the inventors PitchHub, and labeled PitchHub Domain, has an Internet-connected server 102, communicating on Internet backbone 120, which represents all of the interconnected networks that comprise the well-known Internet network. Server 102 is also coupled to a data repository 103. Server 102 comprises a processor executing software (SW) 104 that provide in part a web site comprising services described in enabling detail below. SW 104 is in actuality, in embodiments of the invention, a rich portfolio of coded instructions providing a broad range of functionality, including a web site, but beyond just the web site.

Enterprise 105, labeled Enterprise n, also shown as coupled to the Internet backbone 120, represents any number of enterprises connected to the Internet that may interact with PitchHub to provide services to PitchHub, and for clients of PitchHub. Such enterprises, for example, may include cloud storage, Blockchain providers, and video enterprises, such as Vimeo™ and others, for example.

As briefly described above, in the Background section, persons who have a need for soliciting bids on projects range from individuals, who may be, for example, homeowners seeking qualified contractors for repair and maintenance services, to agents for government agencies, to small and large businesses seeking bids for various endeavors. Abstractly speaking, the needs are defined in projects, and every project will have an author, which may be a person or a committee. In this specification, the originator and manager of a project is termed the Project Author, abbreviated PA, and the enterprise or person responding to a request for bids is termed the Bidder.

An overall function of the PitchHub domain is to provide a service wherein PAs may have access to tools and guidance to define their varied projects, and also to promote their projects to qualified bidders who may want to compete for the privilege of providing whatever product or service may be sought by a PA. Both PAs and Bidders, to be a part of the process provided by PitchHub need to connect to domain 101 through server 102. This is done by use of network-capable devices typically using browsing applications.

In FIG. 1 a laptop computer 122, representing many such, executing software 123, is connected to Internet backbone 120 through Internet Service Provider (ISP) 121. Such devices may be used by any PA or Bidder to interact with PitchHub. A desktop computer 124, representing many such, is shown executing SW 125, and is connected to Internet backbone 120, and hence to PitchHub also through ISP 121. These computers may also be used by any PA and by Bidders to interact with PitchHub. Further a smartphone 126, representing many such, is shown connecting to Internet backbone 120 through Gateway 128, typically wirelessly through a cellular network. Such phones may also be used by either PAs or Bidders to Interact with PitchHub. Finally, Enterprise 105 may be a domain hosted by a small business or a large business and may connect departments and individuals throughout that business enterprise by Local Area Networks (LANs) with devices capable of connecting and interacting with PitchHub, and many businesses may take advantage of PitchHub services through this sort of connectivity.

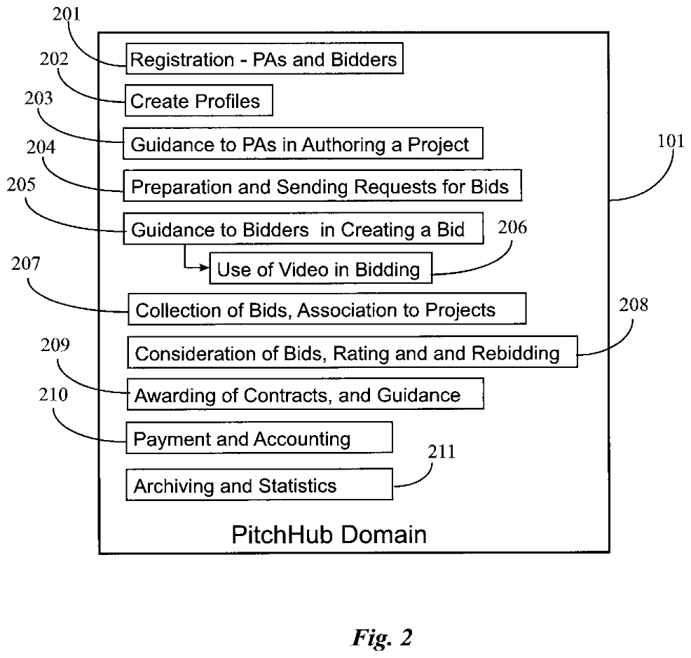

FIG. 2 is a block diagram indicating a range of functionality provided by the PitchHub domain 101 in some embodiments of the invention. Potential PAs, to take advantage of the services of PitchHub have to register following guidance represented by process 201. Bidders may also register in a similar process, either to be considered as bidders, or after having been selected, but before presenting a bid on a project. Both Bidders and PAs, in registration, have a profile created, and the profile may be more than contact information and services provided, but may in some embodiments include, but not be limited to, tracking of participation in specific projects, and performance.

PAs, having registered, may open a project, and follow prompts and guidance in authoring projects in process 203. Once a project is authored, the PA may prepare and send out requests for bids in process 204. Bidders selected and invited to respond to a request may follow guidance in creating a bid in process 205. A related process 206 enabled bidders to prepare and submit bids in videos in a fashion supported and preferred by PitchHub.

Collection of bids and association to projects is accomplished in process 207, and in process 208 bids are rated and considered, and in some cases requests for rebid may be made. Awarding of contracts and guidance for accomplishing same is provided in process 209. Payment and accounting may be accomplished in process 210. And all activity, annotated as to projects and bids, may be archived through process 211, and there may be statistical services, which may relate back to evolution of profiles for both Bidders and PAs.

FIG. 2 is meant to be a relatively abstract indication of types and ranges of services provided by PitchHub, and further enabling detail is provided in several examples below.

### Example 1

The inventors believe enabling detail regarding the various aspects of the instant invention may best be provided in the form of examples. In this example 1 the situation is of a homeowner desirous of heating her family home with a woodstove. This homeowner has been advised by a friend, who has used PitchHub in the past, of the significant advantages of PitchHub, and has asserted the URL of PitchHub.

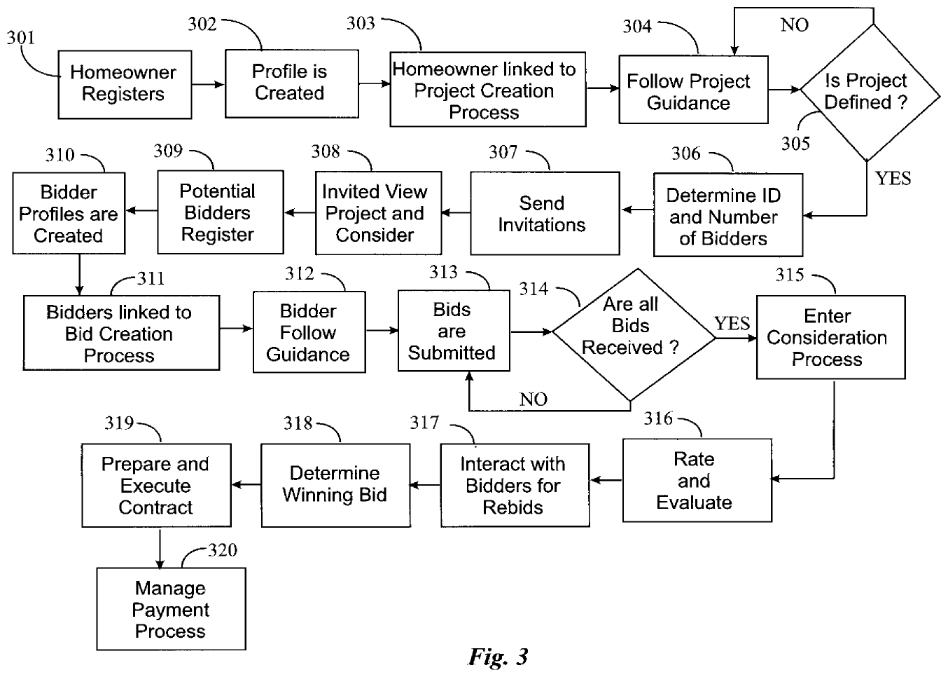

FIG. 3 is a flow diagram depicting the flow of activity in Example 1. At step 301 the homeowner desiring a woodstove and installation asserts the PitchHub URL, and elects to register, by asserting a Registration button on the Home Page. This process is well-known in the art and need not be described in detail. In the process of registration, the homeowner may enter contact information, and may choose a username and a password. In some embodiments single sign on (SSO) may be used as well, in which a trusted organization may authenticate a user and provide user identification to the PitchHub software.

At step 302 a profile is created for the homeowner, with all the contact information, and also capable of recording a great deal more information, such as an activity log, and project archival.

Once the homeowner is registered she is linked at step 303 to a Project creation process, that solicits from the homeowner the nature of the project and the desired final goal. Every new project is accorded a visibility setting, which may be (1) Private to an organization; (2) Private with a sharable link; or (3) Public. If the project is accorded a status of Private to an Organization, only members of that organization are enabled to participate. If Private with a sharable link, an email may be sent to potential Bidders with a link that enables the potential Bidders to view details of the project, but not to interact with the project. In a Public project, or a project where Bidders have been selected and authorized to participate, the potential Bidders may interact by adding text or video comments, by downloading documents from the project library, and to be seen officially as participants in the project.

Returning to FIG. 3, at step 304 the homeowner follows project Guidance, provided through execution of SW 104 on a processor of server 102. There may be in step 304 a hierarchical on-screen guidance program with interactive interfaces to aid the homeowner in becoming a PA.

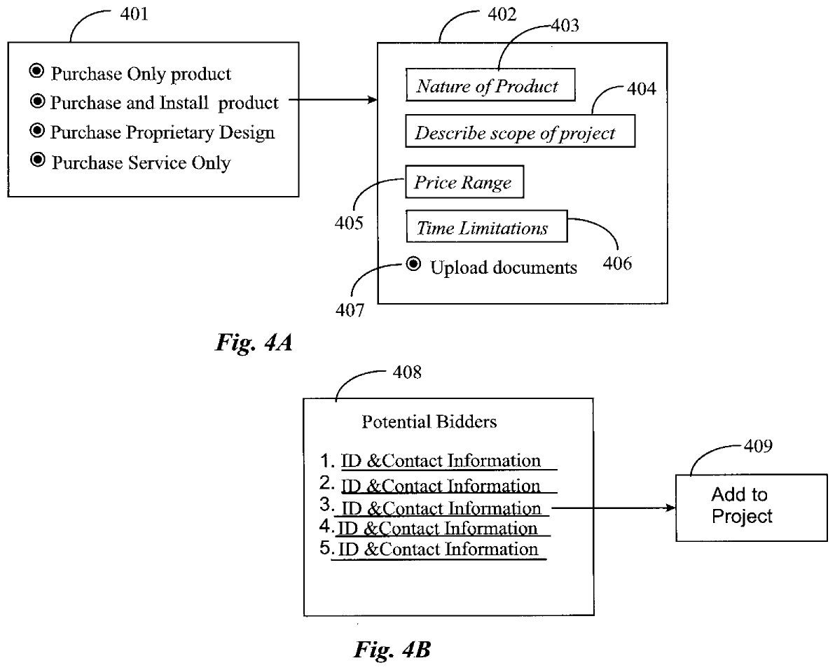

FIG. 4A is an example of interactive interfaces through which the new PA in this example may navigate in preparing a project for purchase and installation of the wood stove. Interface 401, which may be provided in step 304 of FIG. 3, the PA is expected to select a radio button that will guide the process in different ways, depending on the button selected. In this example the PA would select Purchase and Install Product, the product being a wood stove. Upon selection of Purchase and Install Product, a new interface 402 may be presented, in which the PA may enter in field 403 the nature of the product. This may in some embodiments be a drop-down menu, in which product categories may be presented, leading to lower-order menus showing specific products, or even specific brands.

The PA in this example is going to enter that the product desired is a woodstove, and may provide further detail such as size, BTU range and so on. In field 404 the PA may enter the scope of the project. AT 405 a price or a price range may be selected. At field 406, time limitations may be determined. Button 407 allows the PA to upload documents, which may include text documents with descriptions, photographs, videos, and the like, that the PA may wish to make available to potential Bidders.

Returning again to FIG. 3, at step 305 the system tracks progress and determines whether the project is completely defined. If not, control goes back to step 304, then to step 305 again. When the answer at step 305 is YES, then control goes on to step 306, to identify and determine number of bidders.

FIG. 4B illustrates an interactive interface that might be provided regarding potential bidders. In one circumstance there may be a mechanism for the PA to enter preferred businesses or persons to bid on the project. In another circumstance the PitchHub system might control the process of determining potential bidders. The system may search for bidders, for example, based on the geographic location and nature of the project and product. Interface 408 may present a list of potential bidders to the PA, who may select individual ones from the list, which then are added to the project at step 409.

Returning again to FIG. 3, once potential bidders are identified at step 306, invitations are sent to the potential bidders at step 307. These may be by private email, or by other means of communication. In one embodiment, described above as Private with a sharable link, email is incorporated, and invited potential bidders may use the embedded link to enter and view projects to which they have been invited, but may not interact with the project. In this viewing process the potential Bidders are deciding at step 308 whether or not to bid on the project.

Those Bidders who elect to bid must register to PitchHub to do so at step 309, and that registration process will be analogous to the process described above for PAs. Also, in the registration process, a profile is created at step 310 for each new registered business or individual, and the profile will evolve over time with contact information, shared communications, activity archives, and the like. Such profiles over time become sources for selecting potential bidders in new projects, and this use may be nuanced by records of successful interactivity and credibility ratings.

A PA in some embodiments may invite parties other than potential Bidders as participants in a project. In the circumstance of a homeowner buying a woodstove to be installed, there may be no invitations for associated participants on the side of the PA in the project. This, however, may be a common occurrence in projects initiated and conducted through PitchHub by active business interests. In some embodiments there may also be means for Bidders to invite third-party interests in creating bids on projects.

In some embodiments of the invention there may be organized guidance for Bidders in creating bids on projects. A preferred model in PitchHub is that bids be created as video presentations to be presented to the PA or an agent of the PA, for evaluation and eventual selection as a winning bid. In this aspect, Bidders, once registered, and particularly if new to the system, may be directed to a teaching or guidance program for instruction on how to create a video bid in a project. In this process Bidders are made aware of in-browser video creation tools, or may also be referred to third-party video creation programs like, for example, Movavi™. There may be specific step-by-step instructions, but these may be optional, as repeat Bidders will become adept at the process and the requirements.

In some embodiments a defined set of video creation and editing tools may be provided. Also, in some cases selections of background music and other special effects may be provided for Bidders to use in their videos. Bidders may also be free to enhance their Bid videos in other ways outside of guidance from PitchHub. Bidders follow such guidance and suggestion at step 312 and upload their video bids to specific projects at step 313.

At step 314, received bids are tracked against known Bidders, until all bids are received. There may also be time considerations imposed by a PA, such that some bids may be disqualified if not received in the time frame. At step 315 the project enters a Consideration process. The consideration process involves the PA, or agents of the PA, viewing and evaluating the submitted video bids, and rating and comparing, toward selecting a winning bid. Invited parties may aid the PA in this process.

In some embodiments video editing and annotation tools may be provided to PAs and their agent participants, enabling them to annotate Bidders videos with bookmarks and comments for example, to facilitate sharing the videos between agents in the evaluation process. Copies of videos may be made to be annotated in different ways.

After a round of consideration, there may be questions regarding some of the bids, or opportunities seen for improving bids. At step 317 the PA and agents may communicate with bidders to request certain alterations or amendments, for example, and some bids may be amended and returned, or dropped. When all of this evaluation process is finished, at step 318 the PA may determine the winning bid. At this point a letter or email may go out to the winning bidder, informing the Bidder of the decision. The losing Bidders may also be informed and encouraged to bid on other projects.

In some embodiments there may be a program for helping PAs and winning Bidders to execute a contract. Contract templates for different sorts of projects may be stored and provided, to be considered in step 319, and in some circumstances legal advice may be made available, or PAs and Bidders may be referred to preferred legal firms, who may also be registered to PitchHub. In some cases execution of the contract, which in this example involve shipping and receiving the wood stove, perhaps execution of a building permit, installation, testing, and evaluation, may be tracked and archived for future reference.

In some cases, a payment process may be managed through PitchHub, which may involve initial and periodic payments, and in some circumstances, debt financing. Execution of payment agreements may also become a part of profiles for both PAs and Bidders and may be made available for future considerations in other projects.

Example 1 described above is a simple example of a straightforward project for purchasing and installing a product. There are more complicated scenarios and uses.

### Example 2

In some embodiments PitchHub may be used by Investors to solicit consideration by enterprises having need of investment. In this aspect, an investor, who may be an individual or, for example, a Venture Capital enterprise, may author a project, and in the project may set criteria, such as a specific technology area, Self-Driving AI, for example, and perhaps a window of 1^{st} round financing amount, and perhaps other criteria, and broadcast the project to known startup enterprises and the like, who may respond. In an analogy to the purchase of a product or service as a project, the investor may have in mind just a single investment in a single enterprise, which would allow the responding enterprises to compete for the investment.

In another aspect, a startup organization may create a project to pitch the company for a round of investment. In this example there still needs to be a PA, and there may well be a number of other participants invited by the PA in creating the project. And the PA must be registered to PitchHub and have a profile. The project may, in many respects, closely resemble what is known in the art as a Pitch Deck, and may ultimately take the form of a Video or PowerPoint presentation.

Once such a project is created, selection of Bidders, henceforth Investors, in this example, certainly will differ from the process in example 1. Investors selected to receive the Investment Project may be Venture Capital firms, companies in similar lines of technology, or individuals perhaps known to be private investors. Potential investors that may review projects (step 308), and elect to bid, also must register to PitchHub, if not already registered. In this example Investors may provide a video pitch as to nature of investment, equity considerations, and much more. In considerations of bids the originator may ultimately select an investment partner. In some case, however, the process may simply engage a startup enterprise with an investor, after which the two will be free to continue a dialogue beyond PitchHub.

### Example 3

In some embodiments enterprises that maintain purchasing departments charged with soliciting bids on repair and maintenance parts, for example, may become members of PitchHub for all or a portion of their projects. In many cases these projects will involve provision of blueprints, and specific technical requirements for parts to be purchased.

### Example 4

Another significant use of PitchHub may be used by persons or organizations looking for particular coaching or other guidance. A PA, for example, may want life guidance, religious guidance, or input of almost any sort. The pitch is the product of the PA, as is the ultimate selection of recipients of the pitch, and consideration of video presentations offered in return.

The skilled person will understand that the embodiments described above are exemplary only, and not limiting. There may be similar processes for performing the functionality described that are not beyond the scope of the invention. The invention is limited only by the scope of the claim below.

We claim:

1. A system for competitive bidding on defined projects, comprising:
an Internet-connected server hosted by a first enterprise, executing software on a processor from a non-transitory medium, providing a web site;
a plurality of Internet-connected, computerized devices used by participants in interacting with the first enterprise;
a registration process wherein project authors (PAs) are registered to interact with the system, and profiles are created and maintained for each registered PA;
first interactive interfaces provided to PAs using individual ones of the computerized devices connected to the web site, enabling and guiding the PAs to create projects, to select potential bidders, and to invite the potential bidders to bid on the projects;
second interactive interfaces provided to potential Bidders responding to invitations to register as Bidders, creating profiles for the Bidders; and
third interactive interfaces provided to Bidders, enabling and guiding the Bidders to create video-based bids on projects, and to submit the bids to the PAs of the projects;
wherein PAs play the video-based bids associated with projects and select one Bidder to implement the project.

2. The system of claim 1 wherein projects created are accorded a status as either private, shared only with members of a specific organization, private with a shareable link, or public to anyone.

3. The system of claim 2 wherein, in processing a project with a shareable link, projects are communicated to selected potential bidders in emails having a link connecting the potential bidders back to the enterprise web site and enabling the potential bidders to view details of the projects to which they have been invited as potential bidders.

4. The system of claim 3 wherein potential bidders deciding to bid on projects to which they are registered, are enabled to submit the video-based bids prepared to be considered by PAs of the associated projects.

5. The system of claim 1 wherein activities of PAs and Bidders are recorded in profiles associated with the PAs and Bidders.

6. The system of claim 1 wherein projects are based on purchase of physical entities, either commercially available or manufacturable.

7. The system of claim 6 wherein projects include purchase and installation of physical entities.

8. The system of claim 1 wherein projects are based on investment for new businesses, investors are authors, and bidders are enterprises seeking investment.

9. The system of claim 1 wherein projects are created by authors seeking instruction or coaching, and bidders selected and invited are persons or enterprises capable of providing specific instruction or coaching described in the projects.

10. The system of claim 1 wherein, at conclusion of a project, a project summary and report is prepared and recorded at least in the PAs profile.

11. A method enabling competitive bidding on defined projects, comprising:
registering project authors (PAs) with associated profiles to an enterprise hosting a web site provided by software executing on a processor of an Internet-connected server;
enabling and guiding registered PAs to create projects through interactive interfaces provided to first computerized devices connected to the web site, used by the PAs, and executing a browser program, and to select potential bidders, and to invite selected potential bidders to bid on the projects;
registering potential bidders, using second internet-connected computerized devices executing browser programs, who choose to respond to projects, as bidders with profiles;
enabling and guiding bidders through second interactive interfaces, in preparing video-based bids on specific projects, and to submit the bids to the web site to be associated with specific projects; and
enabling the PAs to play and consider the video-based bids, and to select one bidder to implement the project.

12. The method of claim 11 comprising according a status as either private, shared only with members of a specific organization, private with a shareable link, or public to anyone to each project created.

13. The method of claim 12 wherein, in processing a project with a shareable link, projects are communicated to selected potential bidders in emails having a link connecting the potential bidders back to the enterprise web site and enabling the potential bidders to view details of the projects to which they have been invited as potential bidders.

14. The method of claim 13 wherein potential bidders deciding to bid on projects to which they are registered, are enabled to submit the video-based bids prepared to be considered by PAs of the associated projects.

15. The method of claim 11 comprising recording activities of PAs and Bidders in profiles associated with the PAs and Bidders.

16. The method of claim 11 wherein projects are be based on purchase of physical entities, either commercially available or manufacturable.

17. The method of claim 16 wherein projects include purchase and installation of physical entities.

18. The method of claim 11 wherein projects are based on investment for new businesses, investors are authors, and bidders are enterprises seeking investment.

19. The method of claim 11 wherein projects are created by authors seeking instruction or coaching, and bidders selected and invited are persons or enterprises capable of providing specific instruction or coaching described in the projects.

20. The method of claim 11 comprising preparing a summary and report at conclusion of a project and recording the summary or report at least in the PAs profile.
